(19) United States
(12) Patent Application Publication
(10) Pub. No.: US 2013/0222363 A1
(43) Pub. Date: Aug. 29, 2013

(54) STEREOSCOPIC IMAGING SYSTEM AND METHOD THEREOF

(71) Applicants: Lun-Cheng CHU, Taoyuan County (TW); Yun-Long TUN, Taoyuan County (TW)

(72) Inventors: Lun-Cheng CHU, Taoyuan County (TW); Yun-Long TUN, Taoyuan County (TW)

(73) Assignee: HTC CORPORATION, Taoyuan City (TW)

(21) Appl. No.: 13/403,703

(22) Filed: Feb. 23, 2012

(51) Int. Cl. G06T 15/00; G06F 3/041

(52) U.S. Cl. 345/419

(57) ABSTRACT

A stereoscopic imaging method for a stereoscopic imaging system is provided. The stereoscopic imaging method comprises using a processor to perform the following steps of: rendering a three-dimensional scene with at least one object and a manipulating area comprising a corresponding plane of the object; generating and displaying at least one stereoscopic image comprising the three-dimensional scene and the updated object; receiving a plurality of touch-control commands; manipulating the corresponding plane of the object according to the touch-control commands; updating the object in the three-dimensional scene with the manipulated corresponding plane; and updating the stereoscopic image with the updated object.

### BACKGROUND OF THE INVENTION

1. Field of the Invention

The present invention relates to image processing, and in particular relates to a system and method for manipulating stereoscopic images.

2. Description of the Related Art

With rapid progress and technical development in recent years, there has been strong demand for stereoscopic imaging systems. In computer graphics, a three-dimensional scene may be rendered by a central processing unit (CPU) with graphics library such as OpenGL, and a stereoscopic image can be generated by taking a left-eye image and a right-eye image from the three-dimensional scene. Since more and more hand-held devices (e.g. smart phones, tablet PCs) are capable of displaying stereoscopic images, a user may want to modify or manipulate the content in the three-dimensional scene of a stereoscopic image, thereby increasing user experience.

### BRIEF SUMMARY OF THE INVENTION

A detailed description is given in the following embodiments with reference to the accompanying drawings.

In an exemplary embodiment, a stereoscopic imaging system is provided. The stereoscopic imaging system comprises: a processing unit arranged for rendering a three-dimensional scene with at least one object and a manipulating area comprising a corresponding plane of the object, and generating at least one stereoscopic image comprising the three-dimensional scene and the manipulating area; and a touch-sensitive stereoscopic screen arranged for receiving a plurality of touch-control commands and displaying the stereoscopic image, wherein the processing unit further manipulates the corresponding plane according to the touch-control commands, and updates the stereoscopic image by incorporating the manipulated corresponding plane with the object in the three-dimensional scene.

In an exemplary embodiment, a stereoscopic imaging method for a stereoscopic imaging system is provided. The stereoscopic imaging method comprises using a processor to perform the following steps of: rendering a three-dimensional scene with at least one object and a manipulating area comprising a corresponding plane of the object; generating and displaying at least one stereoscopic image comprising the three-dimensional scene and the manipulating area; receiving a plurality of touch-control commands; manipulating the corresponding plane of the object according to the touch-control commands; updating the object in the three-dimensional scene with the manipulated corresponding plane; and updating the stereoscopic image with the updated object.

In an exemplary embodiment, another stereoscopic imaging system is provided. The stereoscopic imaging system comprises: a processing unit arranged for rendering a three-dimensional scene with at least one object and a manipulating area, and generating at least one stereoscopic image comprising the three-dimensional scene and the manipulating area; and a touch-sensitive stereoscopic screen arranged for receiving a plurality of touch-control commands and displaying the stereoscopic image, wherein the processing unit further updates the stereoscopic image by adjusting a position of the three-dimensional scene relative to the touch-sensitive stereoscopic screen within the manipulating area according to the touch-control commands.

In an exemplary embodiment, another stereoscopic imaging method for a stereoscopic imaging system is provided. The stereoscopic imaging method comprises using a processor to perform the following steps of: rendering a three-dimensional scene with at least one object and a manipulating area; generating at least one stereoscopic image comprising the three-dimensional scene and the manipulating area; receiving a plurality of touch-control commands by a touch-sensitive stereoscopic screen; updating the stereoscopic image by adjusting a position of the three-dimensional scene relative to the touch-sensitive stereoscopic screen within the manipulating area according to the touch-control commands; and displaying the stereoscopic image on the touch-sensitive stereoscopic screen.

In an exemplary embodiment, yet another stereoscopic imaging system is provided. The stereoscopic imaging system comprises: a processing unit arranged for rendering a three-dimensional scene with at least one object and generating at least one stereoscopic image comprising the three-dimensional scene, wherein the object has a relative position to an observer; and a touch-sensitive stereoscopic screen arranged for displaying the stereoscopic image; wherein the processing unit further updates the stereoscopic image by sustaining the relative position of the object to the observer when the stereoscopic imaging system is moved, rotated and/or tilted.

In an exemplary embodiment, yet another stereoscopic imaging method for a stereoscopic imaging system is provided. The stereoscopic imaging method comprises using a processor to perform the following steps of: rendering a three-dimensional scene with at least one object; generating at least one stereoscopic image comprising the three-dimensional scene, wherein the object has a relative position to an observer and updates the stereoscopic image by sustaining the relative position of the object to the observer when the stereoscopic imaging system is moved, rotated and/or tilted; and displaying the stereoscopic image.

### BRIEF DESCRIPTION OF THE DRAWINGS

The present invention can be more fully understood by reading the subsequent detailed description and examples with references made to the accompanying drawings, wherein:

FIG. 1 illustrates a block diagram of the stereoscopic imaging system according to an embodiment of the invention;

FIG. 2 illustrates a diagram of the user interface of the stereoscopic imaging system according to an embodiment of the invention;

FIG. 3A-3C illustrate a diagram of the procedure of generating a stereoscopic image according to an embodiment of the invention;

FIG. 4A-4C illustrates a diagram of manipulating the three-dimensional object according to an embodiment of the invention;

FIG. 5 illustrates a flow chart of the stereoscopic imaging method according to an embodiment of the invention;

FIG. 6 illustrates a flow chart of the stereoscopic imaging method according to another embodiment of the invention; and

FIG. 7 illustrates a flow chart of the stereoscopic imaging method according to yet another embodiment of the invention.

### DETAILED DESCRIPTION OF THE INVENTION

The following description is of the best-contemplated mode of carrying out the invention. This description is made for the purpose of illustrating the general principles of the invention and should not be taken in a limiting sense. The scope of the invention is best determined by reference to the appended claims.

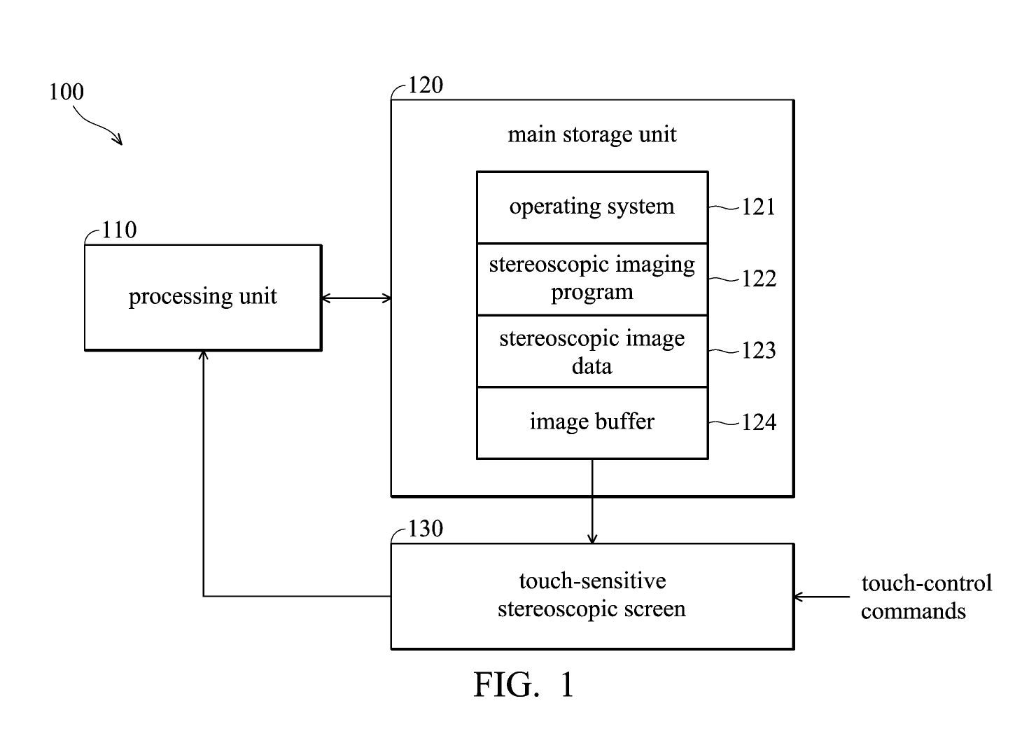

FIG. 1 illustrates a block diagram of the stereoscopic imaging system according to an embodiment of the invention. The stereoscopic imaging display system 100 may comprise a processing unit 110, a main storage unit 120 and a touch-sensitive stereoscopic screen 130. The processing unit 110 is arranged for executing various types of processing according to programs stored in the main storage unit 120. The processing unit 110 can be a central processing unit (CPU) or equivalent circuits. The main storage unit 120 is arranged to store programs and data necessary for execution of control processes. In an embodiment, the data stored in the main storage unit 120 may comprise an operating system 121, a stereoscopic imaging program 122, stereoscopic image data 123 and an image buffer 124 (details will be described later). For example, the main storage unit 120 can be a non-volatile memory (e.g. a hard-disk, ROM, etc.) or a volatile memory (e.g. DRAM, SRAM, etc.). The touch-sensitive stereoscopic screen 130 is arranged for receiving a user's touch-control commands and displaying stereoscopic images of a three-dimensional scene based on parallax effect. The touch-sensitive stereoscopic screen 130 can be a stereoscopic display panel viewed by naked eyes, polarizing glasses or shutter glasses, but the invention is not limited thereto.

In an embodiment, the processing unit 110 may execute the operating system 121 and the stereoscopic imaging program 122, as well as the touch-control commands received by the touch-sensitive stereoscopic screen 130. Then, the stereoscopic imaging program 122 may generate and update the corresponding stereoscopic image data 123 of the three-dimensional scene. The processing unit 110 may further store the stereoscopic images, which are to be displayed on the touch-sensitive stereoscopic screen 130, in the image buffer 124.

In another embodiment, the stereoscopic imaging program 122 may render at least one three-dimensional object in the three-dimensional scene. For example, the three-dimensional object can be rendered by OpenGL, which is a well-known computer graphics library, but the invention is not limited thereto. The stereoscopic imaging program 122 may capture the three-dimensional object from views of both the left eye and the right eye, respectively, thereby generating the stereoscopic image pair (i.e. left-eye image and right-eye image) and updating the stereoscopic image data 123. Then, the stereoscopic image of the three-dimensional object can be displayed on the touch-sensitive stereoscopic image screen 130.

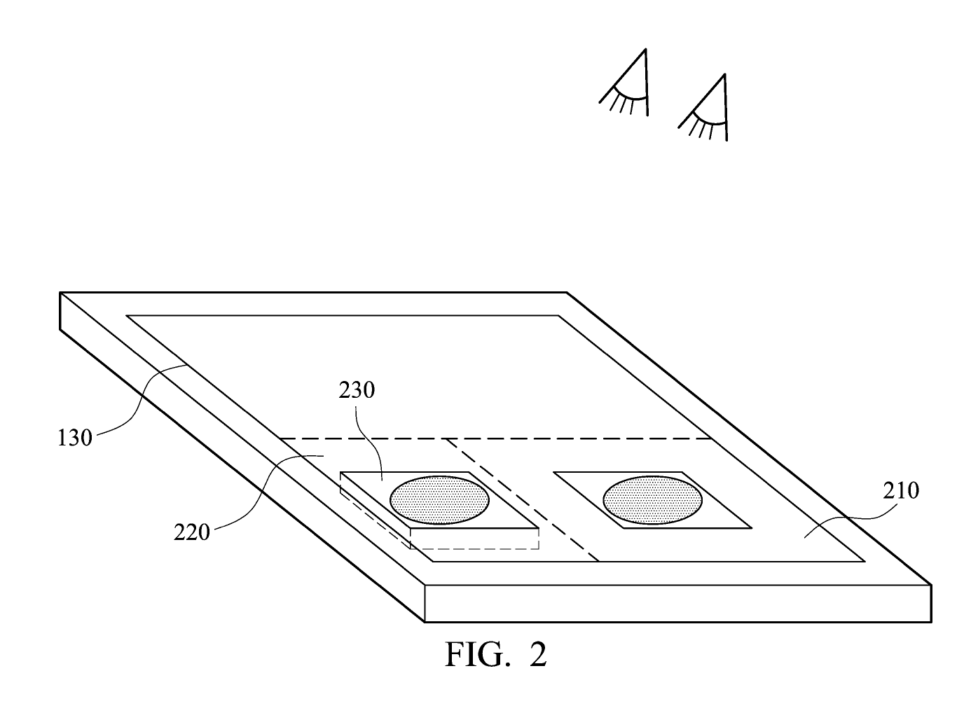

In another embodiment, the stereoscopic imaging program 122 may further integrate a user interface with output stereoscopic images of the three-dimensional scene, and thus a user can manipulate (e.g. draw with lines, paint with colors, rotate, move, etc, but not limited) a selected plane of the three-dimensional object with the user interface displayed by the touch-sensitive stereoscopic screen 130. Specifically, the touch-sensitive stereoscopic screen may receive a plurality of touch-control commands from the user to manipulate the three-dimensional object. For example, the user interface may contain at least one manipulating area 210, and a thumbnail surface view 220 of the three-dimensional object 230, as illustrated in FIG. 2. It should be noted that the manipulating area observed by the user is two-dimensional. That is, the stereoscopic imaging program 122 may set the manipulating area 210 with zero parallax, and therefore the manipulating area 210 can be displayed on the surface of the touch-sensitive stereoscopic screen 130. Meanwhile, the stereoscopic imaging program 122 may also display the three-dimensional object 230 on the touch-sensitive stereoscopic screen 130 with positive parallax, negative parallax or zero parallax. Accordingly, the output stereoscopic image displayed on the touch-sensitive stereoscopic screen comprises the three-dimensional object 230 and the two-dimensional user interface. Further, if there is more than one three-dimensional object in the three-dimensional scene, and the stereoscopic imaging program 122 may set different three-dimensional object with different parallax.

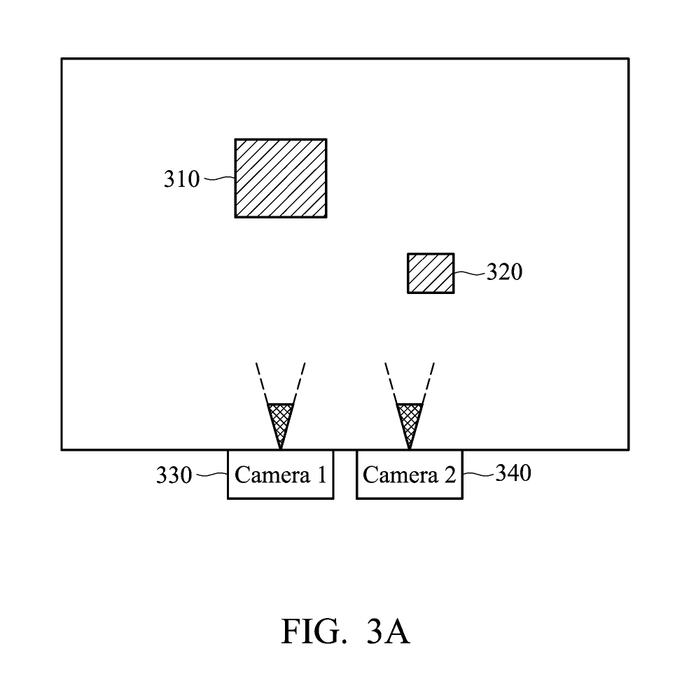

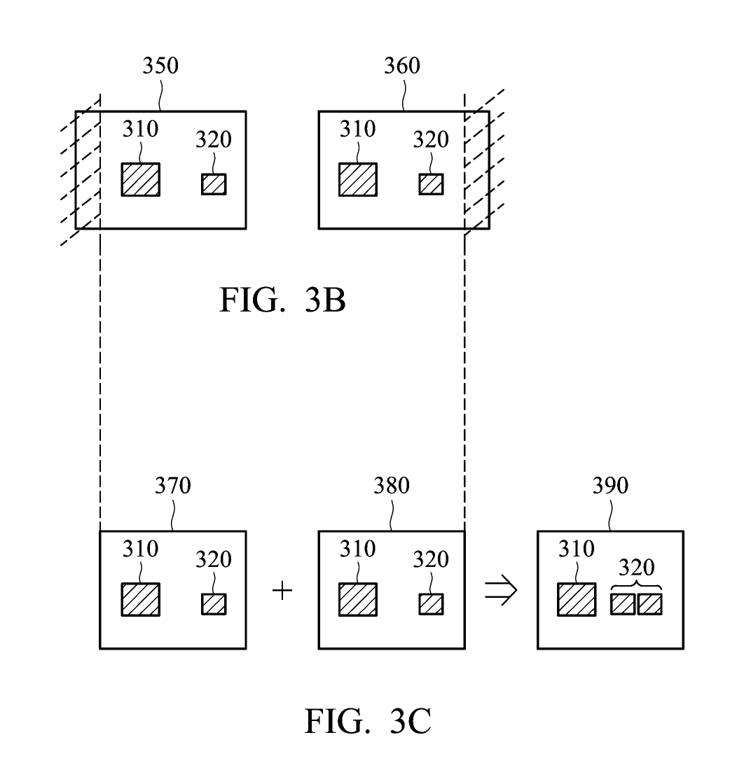

For example, the three-dimensional scene 300 comprises two three-dimensional objects 310 and 320, as illustrated in FIG. 3A. The three-dimensional scene 300 is captured by a left-eye camera 330 and a right-eye camera 340 simultaneously, thereby generating the left-eye image 350 and the right-eye image 360, as illustrated in FIG. 3B. The stereoscopic imaging program 122 may adjust the left-eye image 350 and the right-eye image 360 to generate a left-eye image 370 and a right-eye image 380, as illustrated in FIG. 3C. Specifically, the left region of the left-eye image 350 and the right region of the right-eye image 360 are cut off by the stereoscopic imaging program 122. The output stereoscopic image 390 is then obtained by displaying the left-eye image 370 and the right-eye image 380 alternately. However, the three-dimensional object 310 is larger than the three-dimensional object 320. Thus, the positions of the three-dimensional object 310 in the left-eye image 370 and the right-eye image 380 are overlapped, and the three-dimensional object 310 is observed with zero parallax in the output stereoscopic image 390. Meanwhile, there is an offset between the positions of the three-dimensional object 320 in the left-eye image 370 and the right-eye image 380, and therefore the three-dimensional object 320 is observed with negative parallax in the output stereoscopic image 390. For those who skilled in the art, it should be realized that the parallax of different objects in a three-dimensional scene can be adjusted freely by the stereoscopic imaging program 122 in the invention.

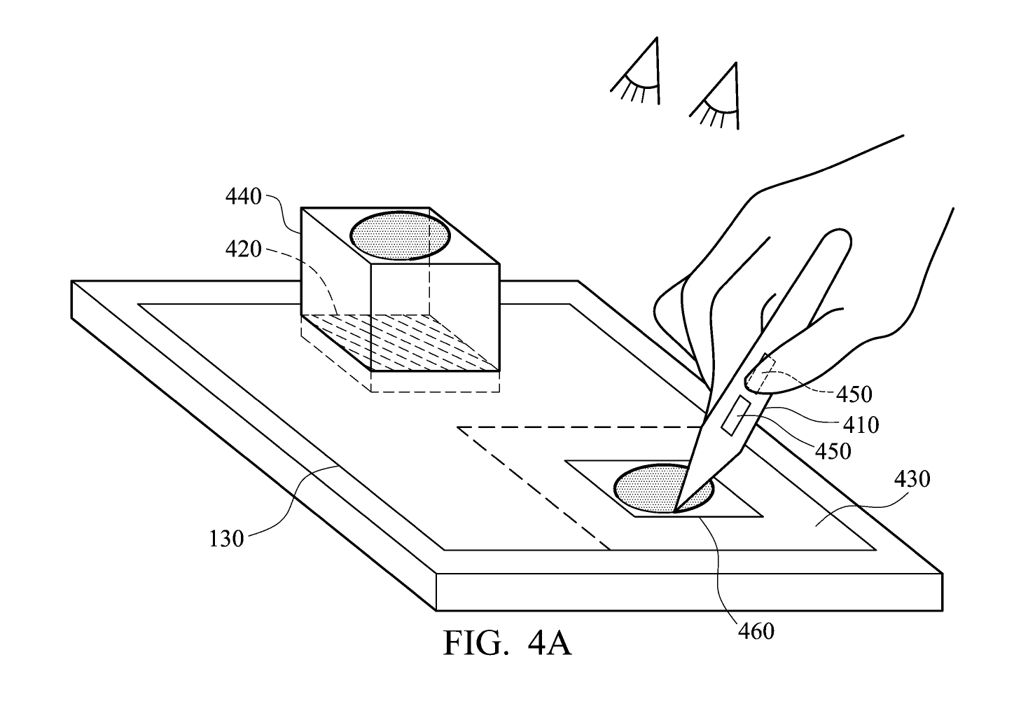

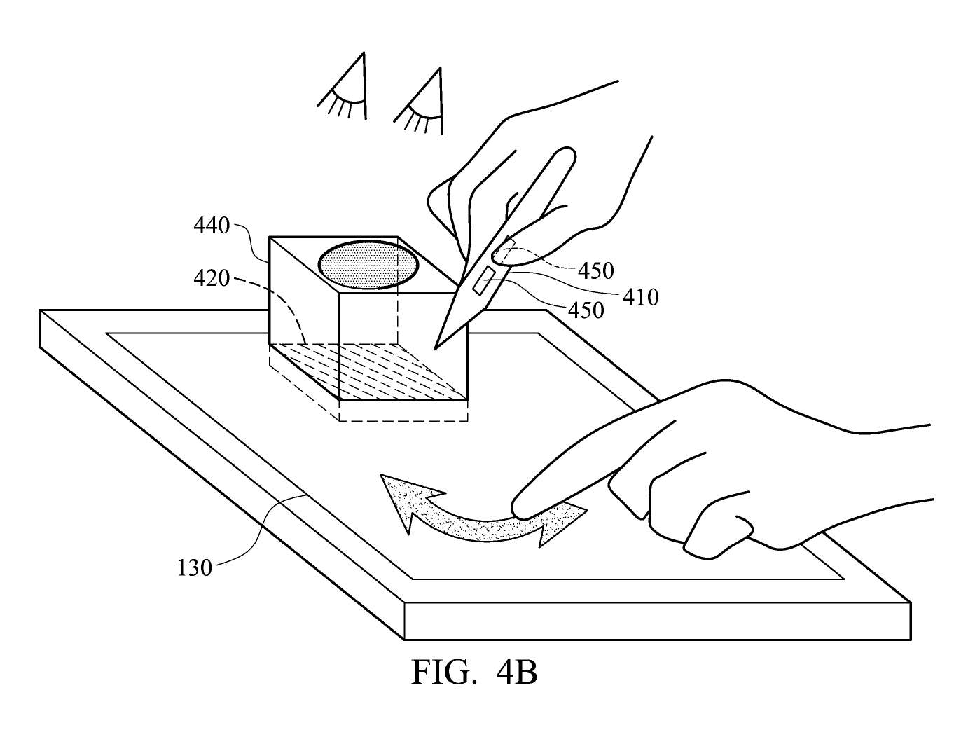

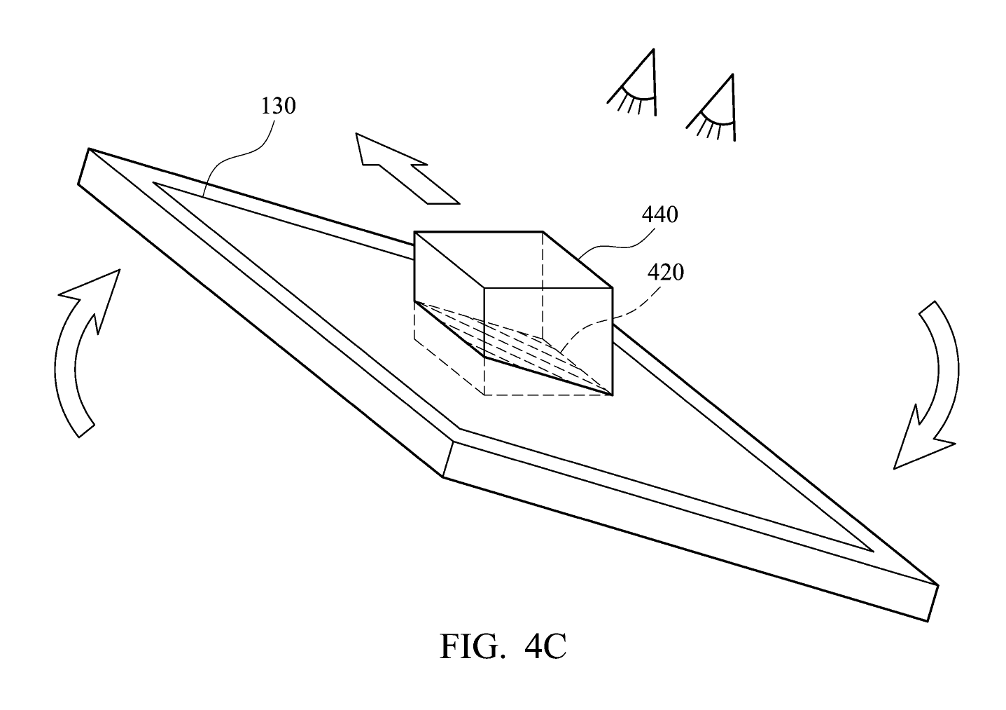

FIG. 4A-4C illustrates a diagram of manipulating the three-dimensional object according to an embodiment of the invention. In yet another embodiment, a user may manipulate the three-dimensional object with at least one fingertip or a stylus 410 on the manipulating area 430, as illustrated in FIG. 4A, wherein the solid lines indicate the portion of the object 440 with negative parallax, and the dashed lines indicate the portion of the object with positive parallax. When the three-dimensional object is displayed on the touch-sensitive stereoscopic screen 130, there might be a cross-section area 420 between the three-dimensional object 440 and the surface of the touch-sensitive stereoscopic screen 130 (i.e. zero parallax surface). The stereoscopic imaging system may determine the cross-section area 420 and display the cross-section area 420 on the manipulating area 430. Further, the user may use the stylus 410 to “manipulate” the cross-section area 420, such as drawing lines, painting colors, etc., but the invention is not limited thereto. Accordingly, the processing unit 110 may receive corresponding touch-control commands by the manipulating action, control the stereoscopic imaging program 122 to label the corresponding manipulated cross-section area 420 for convenience, and display corresponding manipulated cross-section area 420 of the three-dimensional object 440 on the touch-sensitive stereoscopic screen 130. It should be noted that the corresponding plane 460 may be a surface of the object 440 or the cross-section area 420 between the three-dimensional object 440 and the touch-sensitive stereoscopic screen 130, and the cross-section area 420 can be one of the surfaces of the three-dimensional object 440 (e.g. a cube).

The user may also use the stylus 410 and at least one fingertip to manipulate the three-dimensional object 440. For example, the stylus 410 may comprise control buttons for generating a control signal and the processing unit 110 may adjust the parallax of the portion of the three-dimensional object 440 according to the control signal from the stylus 410. The processing unit 110 may also move, rotate or tilt the three-dimensional object 440 in response to the touch-control command from the at least one fingertip, as illustrated in FIG. 4B.

In yet another embodiment, the stereoscopic imaging program 122 can further integrate several thumbnail views in the user interface, where each thumbnail view may represent a two-dimensional surface of the three-dimensional object at a predetermined viewing angle. Alternatively, a user may also select the desired surface for manipulation by using a stylus or at least one fingertip sliding on one thumbnail view of the user interface, so that the three-dimensional object can be rotated. Therefore, a user may select one of the thumbnail views or rotate the three-dimensional object to manipulate the selected surface. The stereoscopic imaging program 122 may optionally adjust the portion of the three-dimensional object in the output stereoscopic image, so that the selected surface of the three-dimensional object is next to the surface of the touch-sensitive stereoscopic screen 130. Specifically, the depth and/or the horizontal/vertical position for the portion of the three-dimensional object may be adjusted accordingly by the stereoscopic imaging program 122.

As described above, a user may adjust the parallax of objects in a three-dimensional scene by using at least one fingertip or a stylus on the manipulating area. In another embodiment, the user may also move or rotate the stereoscopic imaging system 100. The stereoscopic imaging system 100 may further comprises an accelerator sensor and a gyroscope. When the stereoscopic imaging system 100 is moved by the user, the accelerator sensor may detect the moving direction and the moving speed of the stereoscopic imaging system 100. When the stereoscopic imaging system 100 is rotated or tilted by the user, the gyroscope may detect the angle speed of the stereoscopic imaging system 100. Accordingly, the processing unit 110 may further control the stereoscopic imaging program 122 to keep objects in the three-dimensional scene sustained at their original positions according to the moving direction, moving speed and/or the angle speed of the stereoscopic imaging system 100 detected by the accelerator sensor and the gyroscope, respectively. Specifically, the positions of the objects in the three-dimensional scene remain fixed upon being rendered by the stereoscopic imaging program 122 unless the position is changed by the user within the manipulating area. That is, the first relative position between the rendered three-dimensional objects and the user may be fixed, and the second relative position between the rendered objects and the stereoscopic imaging system 100 may vary when the stereoscopic imaging system 100 is moved. It should be noted that the viewing angle of the rendered object may vary seamlessly within the three-dimensional scene when the stereoscopic imaging system 100 is moved, rotated or tilted, as illustrated in FIG. 4C.

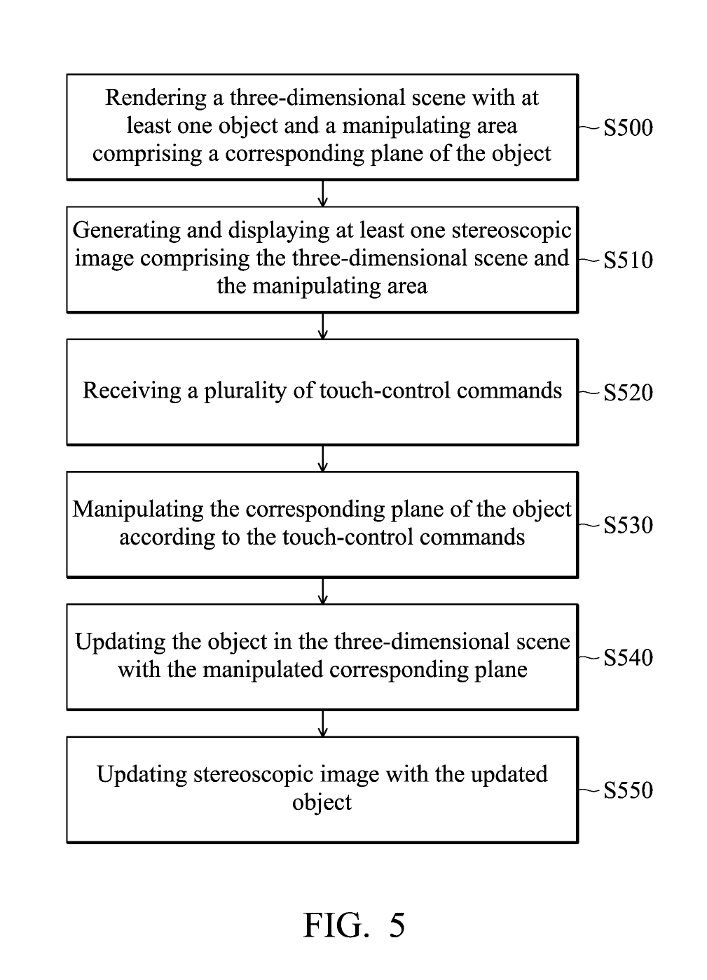

FIG. 5 illustrates a flow chart of the stereoscopic image manipulating method according to an embodiment of the invention. Referring to FIG. 4A and FIG. 5, in step S500, the processing unit 110 may execute the stereoscopic imaging program 122 to render a three-dimensional scene with at least one object (e.g. object 440) and a manipulating area comprising a corresponding plane 460 of the object 440. The corresponding plane 460 of the object 440 may be a surface of the object 440 or a cross-section area between the object 440 and the touch-sensitive stereoscopic screen 130. In step S510, the processing unit 110 may further generate at least one stereoscopic image comprising the three-dimensional scene and the manipulating area 430. The manipulating area 430 is a two-dimensional region with zero parallax. In step S520, the touch-sensitive stereoscopic screen 130 may receive a plurality of touch-control commands (by a stylus or at least one fingertip).

In step S530, the processing unit 110 may manipulate (e.g. draw with lines, paint with colors, etc.) the corresponding plane of the object according to the touch-control commands. In step S540, the processing unit 110 may update the object 440 in the three-dimensional scene with the manipulated corresponding plane. In step S550, the processing unit 110 may update the stereoscopic image with the updated object, and display the updated stereoscopic image on the touch-sensitive stereoscopic screen 130. It should be noted that the steps of FIG. 5 illustrates a three-dimensional painter. In the invention, a user may observe the three-dimensional scene from the stereoscopic image and manipulate (draw with lines, paint with colors, etc.) a plane of the object in the three-dimensional scene.

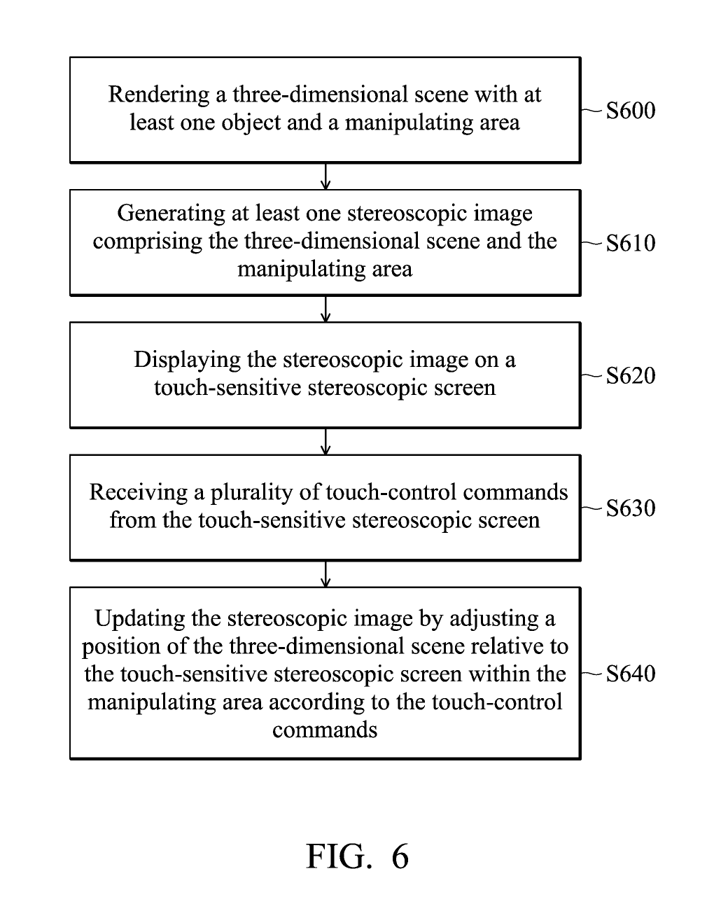

FIG. 6 illustrates a flow chart of the stereoscopic imaging method according to another embodiment of the invention. Referring to FIGS. 4A-4B and FIG. 6, in step S600, the processing unit 110 may execute the stereoscopic imaging program 122 to render a three-dimensional scene with at least one object 440 and a manipulating area 430 comprising a corresponding plane 460 of the object 440. The corresponding plane 460 of the object 440 may be a surface of the object or a cross-section area between the object 440 and the touch-sensitive stereoscopic screen 130. In step S610, the processing unit 110 may generate at least one stereoscopic image comprising the three-dimensional scene and the manipulating area and display the stereoscopic image on the touch-sensitive stereoscopic screen 130. The manipulating area may be a user interface for manipulating the object in the three-dimensional scene. In step S620, the touch-sensitive stereoscopic screen may receive a plurality of touch-control commands (by a stylus 410 or at least one fingertip) and display the stereoscopic image.

In step S630, the processing unit 110 may update the stereoscopic image by adjusting the position of the three-dimensional scene relative to the touch-sensitive stereoscopic screen within the manipulating area according to the touch-control commands, wherein the position of the three-dimensional scene might be adjusted in a horizontal direction and/or vertical direction. The processing unit 110 may also adjust the parallax of the three-dimensional scene to alternate the depth of the three-dimensional scene in the stereoscopic image observed by a user. That is, the object 440 can be moved along the direction perpendicular to the surface of the touch-sensitive stereoscopic screen 130 (i.e. the normal direction). It should be noted that the steps of FIG. 6 can be incorporated with that of FIG. 5. For example, steps S530˜S550 can be executed before/after step S630. That is, the user may adjust the object 440 in the three-dimensional scene of the stereoscopic image to a desired position before/after manipulating the corresponding plane of the object.

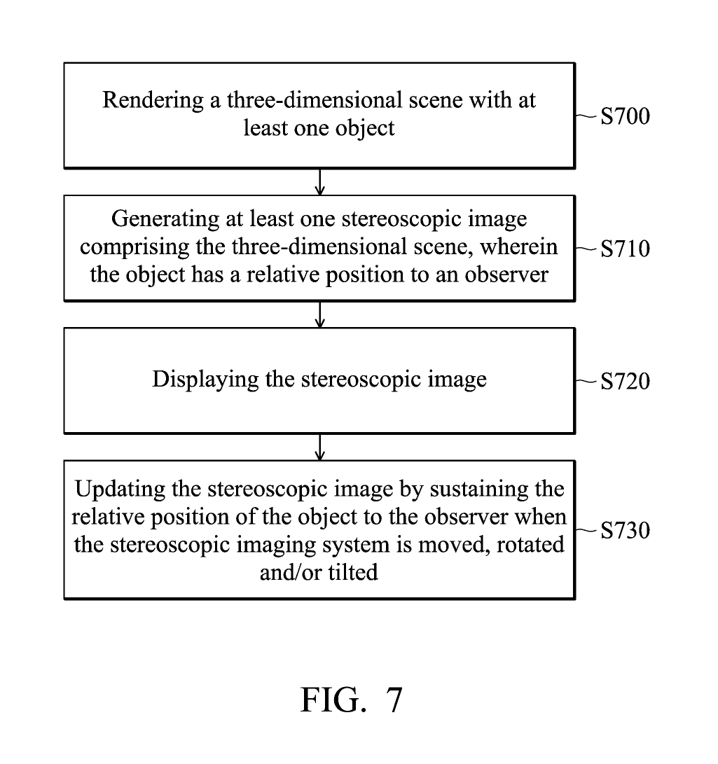

FIG. 7 illustrates a flow chart of the stereoscopic imaging method according to yet another embodiment of the invention. Referring to FIG. 4C and FIG. 7, in step S700, the processing unit 110 may execute the stereoscopic imaging program 122 to render a three-dimensional scene with at least one object 440 (optionally with a manipulating area 420 illustrated in FIG. 4A). In step S710, the processing unit 110 may generate at least one stereoscopic image comprising the three-dimensional scene. The object 440 in the three-dimensional scene has a relative position to the observer. In step S720, the processing unit 110 may display the stereoscopic image on the touch-sensitive stereoscopic screen 130. In step S730, the processing unit 110 may update the stereoscopic image by sustaining the relative position of the object 440 to the observer when the stereoscopic imaging system 100 is moved, rotated and/or tilted.

Specifically, when the stereoscopic imaging system 100 is moved, rotated, and/or tilted, the processing unit 110 may adaptively adjust the relative position between the object in the three-dimensional scene and the stereoscopic imaging system 100 according to the moving speed, moving direction and/or the angle speed detected by the accelerator sensor and the gyroscope, so that the absolute position of the object in the three-dimensional scene in the circumstances (i.e. the physical space) remains unchanged. On the other hand, if the stereoscopic image comprising the three-dimensional scene is observed by an observer, the processing unit 110 may sustain the relative position between the object in the three-dimensional scene and the observer. It should be noted that the steps of FIG. 7 can be incorporated with that of FIG. 5. For example, steps S530˜S550 can be executed before/after step S730. Also, a user may selectively use the steps of FIG. 6 or FIG. 7 to adjust the position of the object in the three-dimensional scene before/after manipulating the corresponding plane of the object.

While the invention has been described by way of example and in terms of the preferred embodiments, it is to be understood that the invention is not limited to the disclosed embodiments. To the contrary, it is intended to cover various modifications and similar arrangements (as would be apparent to those skilled in the art). Therefore, the scope of the appended claims should be accorded the broadest interpretation so as to encompass all such modifications and similar arrangements.

What is claimed is:

1. A stereoscopic imaging system, comprising:
a processing unit arranged for rendering a three-dimensional scene with at least one object and a manipulating area comprising a corresponding plane of the object, and generating at least one stereoscopic image comprising the three-dimensional scene and the manipulating area; and
a touch-sensitive stereoscopic screen arranged for receiving a plurality of touch-control commands and displaying the stereoscopic image,
wherein the processing unit further manipulates the corresponding plane according to the touch-control commands, and updates the stereoscopic image by incorporating the manipulated corresponding plane with the object in the three-dimensional scene.

2. The stereoscopic imaging system as claimed in claim 1, wherein the corresponding plane is a surface of the object or a cross-section area between the object and the touch-sensitive stereoscopic screen.

3. The stereoscopic imaging system as claimed in claim 1, wherein the manipulating area has zero parallax.

4. The stereoscopic imaging system as claimed in claim 1, wherein the touch-control commands can be inputted to the touch-sensitive stereoscopic screen by a stylus and/or at least one fingertip.

5. The stereoscopic imaging system as claimed in claim 1, wherein manipulating the corresponding plane indicates that the processing unit draws the corresponding plane with lines and/or paints the corresponding plane with colors according to the touch-control commands.

6. A stereoscopic imaging method for a stereoscopic imaging system, comprising:
using a processor to perform the following steps of:
rendering a three-dimensional scene with at least one object and a manipulating area comprising a corresponding plane of the object;
generating and displaying at least one stereoscopic image comprising the three-dimensional scene and the manipulating area;
receiving a plurality of touch-control commands;
manipulating the corresponding plane of the object according to the touch-control commands;
updating the object in the three-dimensional scene with the manipulated corresponding plane; and
updating the stereoscopic image with the updated object.

7. The stereoscopic imaging method as claimed in claim 6, wherein the corresponding plane is a surface of the object or a cross-section area between the object and a touch-sensitive stereoscopic screen displaying the stereoscopic image.

8. The stereoscopic imaging method as claimed in claim 6, wherein the manipulating area has zero parallax.

9. The stereoscopic imaging method as claimed in claim 7, wherein the touch-control commands are inputted by a stylus and/or at least one fingertip.

10. The stereoscopic imaging method as claimed in claim 7, wherein the manipulated corresponding plane indicates that the corresponding plane is drawn with lines and/or painted with colors.

11. A stereoscopic imaging system, comprising:
a processing unit arranged for rendering a three-dimensional scene with at least one object and a manipulating area, and generating at least one stereoscopic image comprising the three-dimensional scene and the manipulating area; and
a touch-sensitive stereoscopic screen arranged for receiving a plurality of touch-control commands and displaying the stereoscopic image,
wherein the processing unit further updates the stereoscopic image by adjusting a position of the three-dimensional scene relative to the touch-sensitive stereoscopic screen within the manipulating area according to the touch-control commands.

12. The stereoscopic imaging system as claimed in claim 11, wherein the manipulating area in the stereoscopic image has zero parallax.

13. The stereoscopic imaging system as claimed in claim 11, wherein the touch-sensitive stereoscopic screen receives the touch-control commands from a stylus and/or at least one fingertip.

14. The stereoscopic imaging system as claimed in claim 14, wherein the stylus comprises control buttons for generating a control signal, and the processing unit further adjusts parallax of the object in the three-dimensional scene according to the control signal.

15. The stereoscopic imaging system as claimed in claim 11, wherein the manipulating area comprises a corresponding plane of the object, and the processing unit further draws the corresponding plane with lines or paints the corresponding plane with colors according to the touch-control commands.

16. The stereoscopic imaging system as claimed in claim 15, wherein the corresponding plane is a surface of the object or a cross-section area between the object and the touch-sensitive stereoscopic screen.

17. A stereoscopic imaging method for a stereoscopic imaging system, comprising:
using a processor to perform the following steps of:
rendering a three-dimensional scene with at least one object and a manipulating area;
generating at least one stereoscopic image comprising the three-dimensional scene and the manipulating area;
displaying the stereoscopic image on a touch-sensitive stereoscopic screen;
receiving a plurality of touch-control commands from the touch-sensitive stereoscopic screen; and
updating the stereoscopic image by adjusting a position of the three-dimensional scene relative to the touch-sensitive stereoscopic screen within the manipulating area according to the touch-control commands.

18. The stereoscopic imaging method as claimed in claim 17, wherein the manipulating area in the stereoscopic image has zero parallax.

19. The stereoscopic imaging method as claimed in claim 17, wherein the step of receiving the touch-control commands further comprises:
receiving the touch-control commands from a stylus and/or at least one fingertip by the touch-sensitive stereoscopic screen.

20. The stereoscopic imaging method as claimed in claim 19, further comprising:
adjusting parallax of the object in the three-dimensional scene according to a control signal generated by control buttons of the stylus.

21. The stereoscopic imaging method as claimed in claim 17, wherein the manipulating area comprises a corresponding plane of the object, and the method further comprises:
drawing the corresponding plane with lines and/or painting the corresponding plane with colors according to the touch-control commands.

22. The stereoscopic imaging method as claimed in claim 21, wherein the corresponding plane is a surface of the object or a cross-section area between the object and the touch-sensitive stereoscopic screen.

23. A stereoscopic imaging system, comprising:
a processing unit arranged for rendering a three-dimensional scene with at least one object and generating at least one stereoscopic image comprising the three-dimensional scene, wherein the object has a relative position to an observer; and
a touch-sensitive stereoscopic screen arranged for displaying the stereoscopic image,
wherein the processing unit further updates the stereoscopic image by sustaining the relative position of the object to the observer when the stereoscopic imaging system is moved, rotated and/or tilted.

24. The stereoscopic imaging system as claimed in claim 23, further comprising:
an accelerator sensor for detecting a moving speed and a moving direction of the stereoscopic imaging system; and
a gyroscope for detecting an angle speed of the stereoscopic imaging system.

25. The stereoscopic imaging system as claimed in claim 24, wherein the processing unit sustains the relative position between the object and the observer according to the detected moving speed, the detected moving direction, the detected angle speed or a combination thereof when the stereoscopic imaging system is moved, rotated and/or tilted.

26. The stereoscopic imaging system as claimed in claim 23, wherein the touch-sensitive stereoscopic screen further receives a plurality of touch-control commands, and the processing unit further adjusts a position of the object in the three-dimensional scene according to the touch-control commands.

27. The stereoscopic imaging system as claimed in claim 26, wherein the processing unit further incorporates a manipulating area with zero parallax into the stereoscopic image, wherein the manipulating area comprises a corresponding plane of the object.

28. The stereoscopic imaging system as claimed in claim 27, wherein the processing unit further manipulates the corresponding plane of the object according to the touch-control commands, and updates the object in the three-dimensional scene with the manipulated corresponding plane.

29. A stereoscopic imaging method for a stereoscopic imaging system, comprising:
using a processor to perform the following steps of:
rendering a three-dimensional scene with at least one object;
generating at least one stereoscopic image comprising the three-dimensional scene, wherein the object has a relative position to an observer;
displaying the stereoscopic image; and
updating the stereoscopic image by sustaining the relative position of the object to the observer when the stereoscopic imaging system is moved, rotated and/or tilted.

30. The stereoscopic imaging method as claimed in claim 29, further comprising:
detecting a moving speed and a moving direction of the stereoscopic imaging system; and
detecting an angle speed of the stereoscopic imaging system.

31. The stereoscopic imaging method as claimed in claim 30, further comprising:
sustaining the relative position between the object and the observer according to the detected moving speed, the detected moving direction, the detected angle speed or a combination thereof when the stereoscopic imaging system is moved, rotated and/or tilted.

32. The stereoscopic imaging method as claimed in claim 29, further comprising:
receiving a plurality of touch-control commands; and
adjusting a position of the object in the three-dimensional scene according to the touch-control commands.

33. The stereoscopic imaging method as claimed in claim 32, further comprising:
incorporating a manipulating area with zero parallax into the stereoscopic image, wherein the manipulating area comprises a corresponding plane of the object.

34. The stereoscopic imaging method as claimed in claim 33, further comprising:
manipulating the corresponding plane of the object according to the touch-control commands; and
updating the object in the three-dimensional scene with the manipulated corresponding plane.
